(19) United States
(12) Patent Application Publication
(10) Pub. No.: US 2007/0098432 A1
(43) Pub. Date: May 3, 2007

(54) Image forming device

(76) Inventor: Masami Mashiki, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/259,154

(22) Filed: Oct. 27, 2005

(51) Int. Cl. G03G 15/00

(52) U.S. Cl. 399/88; 399/92

(57) ABSTRACT

An image forming device in which a fixing unit is powered from the power supply, and a cooling unit is driven by electricity obtained by supplying waste heat from the fixing roller to a thermoelectric conversion device. After turning the image forming device ON, when the temperature of the fixing roller reaches a certain temperature thermoelectromotive force is generated in the thermoelectric conversion device. When the power supply is turned OFF, the thermoelectromotive force in the thermoelectric conversion device becomes zero when the temperature of the fixing roller drops to a certain temperature. Also, a delay circuit is provided between the thermoelectric conversion device and the cooling fan, so supply of electricity to the cooling fan is later than the time that thermoelectromotive force is generated, and the time that power supply to the cooling fan stops is also later than the time that the thermoelectromotive force becomes zero.

### FIELD OF THE INVENTION

The present invention relates to an image forming device, and more particularly to cooling the developing system and optical system using the waste heat of the fixing unit.

### BACKGROUND INFORMATION

In image forming devices such as copiers, printers, and facsimiles, in the fixing unit in which toner images are fixed to sheets, fixing rollers are heated by heaters so that when a sheet passes the fixing roller the toner adhering to the sheet is melted. Although part of the heat of the heated fixing roller is used as heat energy to melt the toner, most of the heat is dissipated to the surroundings from the fixing roller as waste heat. Therefore technology is proposed in which the waste heat of the fixing roller is converted into electrical energy using a thermoelectric conversion device based on the Seebeck effect.

When high temperature waste heat emitted from the fixing roller to the surroundings is transferred outside the fixing unit, the temperature within the image forming device rises. This can cause hardening of the toner housed within the developing unit, or deformation of the resin lens within the laser scanner unit for irradiating the photosensitive drum with laser light. To prevent this, a cooling fan is provided near the fixing unit within the image forming device to cool the fixing unit. When this cooling fan is driven the rise in temperature of the fixing unit is prevented, and the temperature rise within the image forming device is suppressed.

However, the cooling fans used in conventional image forming devices are driven by electricity supplied from the power source, the same as for other parts. Therefore, when the power supply of the image forming device is turned ON the fan starts at the same time, and when the power supply of the image forming device is turned OFF the fan stops at the same time. This point is now explained in detail.

As shown in FIG. 8, in a conventional image forming device, when the power supply is turned ON at time T₁ the heater is turned on and the fixing roller starts to be heated. Then the temperature of the fixing roller rises at a fixed rate, and when the temperature of the fixing roller reaches t₁ at time T₂ the temperature of the fixing roller is maintained at a constant temperature by controlling the heater. During this time, as the temperature of the fixing roller rises the temperature within the image forming device also rises. At the time T₂ when the temperature of the fixing roller reaches t₁, the temperature within the image forming device reaches t₂, and thereafter the temperature within the image forming device is also maintained constant.

Thereafter, at time T₃ when the power supply of the image forming device is turned OFF, the power to the heater is also turned off, and the temperature of the fixing roller gradually reduces from t₁. On the other hand, when the power supply is turned OFF the cooling fan also stops. Therefore the temperature within the image forming device temporarily rises higher than the temperature within the image forming device t₂ while the power is ON due to the influence of the waste heat of the fixing device to t₃. In this way, the temperature within the image forming device after the power is turned OFF is higher than the temperature while the power is ON, so the above-mentioned problems can occur.

To overcome this, a thermoelectric conversion device using the Seebeck effect is provided within the image forming device, and the electrical energy obtained by supplying waste heat from the fixing roller to the thermoelectric conversion device is used to drive the cooling fan. As shown in FIG. 9, at time T₄ when the temperature of the fixing roller has risen to t₄, thermoelectric force is generated between the two electrodes of the thermoelectric conversion device, which starts to drive the cooling fan. In other words, the time in which the cooling fan starts to be driven is later by (T₄-T₁) compared with the case where a thermoelectric conversion device is not provided.

As a result of this, when the power supply of the image forming device is turned ON the cooling fan does not also start at the same time to cool the fixing unit. Therefore the rate of rise of the temperature of the fixing roller increases. In other words, as shown in FIG. 9, the slope of the graph representing the change in temperature of the fixing roller is steeper. The time T₂ at which the temperature of the fixing roller reaches t1 is shortened, and the time for the fixing roller to reach the temperature required for fixing is also shortened. Also, at this time the heat emitted from the fixing device per unit time also increases, so the rate at which the temperature of the interior of the image forming device also increases. In other words, as shown in FIG. 9, the slope of the graph representing the change in temperature within the image forming device is steeper, and the time T₂ at which the temperature of the interior of the image forming device reaches t₂ is reduced.

Thereafter, when the power supply and the heater are turned OFF, as shown in FIG. 9, at time T₅ when the temperature of the fixing roller has fallen to t₄ the cooling fan stops. In other words, the time at which the cooling fan stops is delayed by (T₅-T₃) compared with the case where a thermoelectric conversion device is not provided. As a result of this after the power to the image forming device is turned OFF the cooling fan continues to operate, so the temporary rise in temperature of the interior of the image forming device due to the waste heat of the fixing roller is suppressed.

In this way, instead of having a common power source for the image forming device and the cooling fan so that at the same time that the power supply of the image forming device is turned ON the cooling fan also starts, waste heat from the fixing roller is supplied to a thermoelectric conversion device and the electrical energy obtained is used to drive the cooling fan. Then when the power supply is turned OFF the cooling fan continues to operate for a while, so that the temporary rise in temperature of the interior of the image forming device after the power is turned off is suppressed.

Here the thermoelectric conversion device using the Seebeck effect is configured to generate a thermoelectromotive force between two electrodes due to the temperature difference between the metal plates forming the front and rear surface. Therefore, as shown in FIG. 9, thermoelectromotive force is generated at the time T₄ when the temperature of the fixing roller exceeds t₄, and at the time T₅ when the temperature of the fixing roller falls below t₄ generation of the thermoelectromotive force ceases. In other words, at the time when the thermoelectromotive force starts and the time when the thermoelectromotive force ceases, the temperature of the fixing roller is the same.

Therefore, the lower the threshold value of temperature difference at which thermoelectromotive force is generated in the thermoelectric device is set, the longer the cooling fan operates after the power supply to the image forming device is turned OFF, and the longer the temporary temperature rise within the image forming device is suppressed. On the other hand, the lower the threshold value of temperature difference at which thermoelectromotive force is generated in the thermoelectric device is set, the shorter the time after the power supply to the image forming device is turned ON until the cooling fan starts to operate, so the longer the time for the fixing roller to reach the temperature necessary for fixing.

Also, the higher the threshold value of temperature difference at which thermoelectromotive force is generated in the thermoelectric device is set, the longer the time after the power to the image forming device is turned ON until the cooling fan starts to operate, and the shorter the time for the fixing roller to reach the temperature necessary for fixing. On the other hand, the higher the threshold value of temperature difference at which thermoelectromotive force is generated in the thermoelectric device is set, the shorter the time that the cooling fan operates after the power supply to the image forming device is turned OFF. For example, as shown in FIG. 9, due to the influence of the waste heat of the fixing roller the temperature within the image forming device rises temporarily to t5, which is higher than when the power is ON.

In this way, the conventional configuration of an image forming device cannot simultaneously achieve both short time from turning the power supply to the image forming device ON until the fixing roller reaches the temperature necessary for fixing, and prevention of a temporary rise in temperature within the image forming device after the power supply to the image forming device is turned OFF.

With the foregoing points in view, it is an object of the present invention to shorten the time from turning the power supply to the image forming device ON until the fixing roller reaches the temperature necessary for fixing, as well as to prevent a temporary rise in temperature within the image forming device after the power to the image forming device is turned OFF.

### SUMMARY OF THE INVENTION

To achieve the above object, the image forming device of the present invention includes an exposure unit in which laser light irradiates a photosensitive body to form an electrostatic latent image on the surface of the photosensitive body; a developing unit that develops by applying toner to the electrostatic latent image formed on the surface of the photosensitive body; a fixing unit that includes a fixing roller and a heater that heats the fixing roller, and that fixes toner onto a sheet that passes the fixing roller heated by the heater; a thermoelectric conversion device that carries out thermoelectric conversion using waste heat of the fixing unit; and a cooling fan that cools the fixing device, wherein the exposure unit, the developing unit, and the fixing unit are supplied with electrical power by a power source, the cooling fan is driven by electrical power generated by thermoelectric conversion by the thermoelectric conversion device, and the voltage directly output from the thermoelectric conversion device is higher when starting to drive the static cooling fan than when driving the operating cooling fan stops.

In this type of image forming device, a delay circuit is included between the thermoelectric conversion device and the cooling fan, that delays the voltage output from the thermoelectric conversion device to the cooling fan, and outputs the voltage to the cooling fan.

In this way, the voltage output from the thermoelectric conversion device to the cooling fan is delayed by the delay circuit, before being output to the cooling fan. Therefore, when the cooling fan is static, even if the thermoelectric conversion device has started generating a thermoelectromotive force and has output a voltage to the cooling fan, for a while electricity is not supplied to the cooling fan and the cooling fan remains static. On the other hand, when the cooling fan is operating, even if the thermoelectromotive force of the thermoelectric conversion device ceases and the voltage output by the thermoelectric conversion device to the cooling fan becomes zero, the power supply to the cooling fan continues for a while and the cooling fan continues to operate.

In this case, the delay circuit includes an input terminal to which the voltage output from the thermoelectric conversion device is input; a resistance that is connected at a first end to the input terminal; a condenser that is connected at a first end to a second end of the resistance to ground at a second end; and an output terminal that is connected to the node at which the resistance and the condenser are connected and that outputs the output voltage to the cooling fan.

In this way, when the cooling fan is static, when the thermoelectromotive force is generated in the thermoelectric conversion device and voltage starts to be output from the thermoelectric conversion device to the cooling fan a delay is generated by the integration action. Then, when the voltage at the output terminal of the delay circuit is sufficient to drive the cooling fan, electrical power is supplied to the cooling fan and the cooling fan starts to operate. Also, when the cooling fan is operating and the thermoelectromotive force of the thermoelectric conversion device ceases, voltage ceases to be output from the thermoelectric conversion device to the cooling fan. However, electric charge is accumulated in the condenser of the delay circuit, so a voltage capable of driving the cooling fan is output from the output terminal, and electrical power continues to be supplied to the cooling fan for a while after the thermoelectromotive force of the thermoelectric device has ceased.

Also, this type of image forming device includes a switching circuit, so that when the cooling fan is static, electrical power starts to be supplied from the thermoelectric conversion device to the cooling fan when the voltage output from the thermoelectric conversion device reaches a first predetermined voltage. Also, when the cooling fan is operating and the voltage output from the thermoelectric conversion device reaches a second predetermined voltage, supply of electricity from the thermoelectric conversion device to the cooling fan stops. Furthermore, the first predetermined voltage is higher than the second predetermined voltage.

In this way, the voltage output from the thermoelectric conversion device when electrical power starts to be supplied from the thermoelectric conversion device to the cooling fan is set higher than the voltage output from the thermoelectric conversion device when electrical power stops being supplied from the thermoelectric conversion device to the cooling fan. In other words, the thermoelectromotive force generated by the thermoelectric conversion device is set so that it is higher when it is starting to drive a static cooling fan than when it is stops driving an operating cooling fan.

In this case the switching circuit includes an input terminal at which the voltage output from the thermoelectric conversion device is input; a first resistance a first end of which is connected to ground; a second resistance a first end of which is connected to a second end of the first resistance and a second end of which is connected to the power supply; a condenser a first end of which is connected to ground and a second end of which is connected to a second end of the second resistance; a comparator the inverting input terminal of which is connected to the input terminal and the non-inverting input terminal of which is connected to the node to which the first resistance and the second resistance are connected; a switch a first end of which is connected to the input terminal; an output terminal connected to a second end of the switch and which outputs the output voltage to the cooling fan; and a third resistance connected between the non-inverting input terminal of the comparator and the output terminal.

Then, in the switching circuit, after the power supply to the image forming device is turned ON, when the voltage applied to the input terminal, that is the voltage applied to the inverting input terminal of the comparator, rises to the level of the voltage applied to the non-inverting input terminal of the comparator, it becomes low. Therefore the voltage is output from the output terminal with the switch ON. On the other hand, in the switching circuit when the output of the comparator is low, after the power to the image forming device is turned OFF, when the voltage applied to the input terminal, that is the voltage applied to the inverting input terminal of the comparator falls to the level of the voltage applied to the non-inverting input terminal of the comparator, the comparator output becomes high. Therefore the voltage output from the output terminal is zero with the switch OFF.

According to the present invention, the voltage output from the thermoelectric conversion device to the cooling fan is higher when a static cooling fan starts to be driven than when a driven cooling fan stops being driven. Therefore the time period that the cooling fan is operated after the power supply to the image forming device is turned OFF can be longer than with conventional art. Also the temporary rise in temperature within the image forming device after the power to the image forming device is turned OFF due to the waste heat of the fixing roller can be reliably prevented. Also, the time at which the cooling fan starts to be driven can be delayed relative to the time that thermoelectromotive force is generated in the thermoelectric conversion device. Therefore it is possible to shorten the time from turning the power supply to the image forming device ON until the fixing roller reaches the temperature required for fixing.

### BRIEF DESCRIPTION OF THE DRAWINGS

FIG. 1 is an outline figure showing the configuration of an image forming device according to the present invention;

FIG. 2 is a block diagram showing the operation of an image forming device according to the first preferred embodiment;

FIG. 3 is a figure showing the configuration of the delay circuit in an image forming device according to the first preferred embodiment;

FIG. 4 is a figure showing the relationship between operation of the cooling fan, temperature of the fixing roller, and temperature within the image forming device in an image forming device according to the first preferred embodiment;

FIG. 5 is a block diagram showing the operation of an image forming device according to the second preferred embodiment;

FIG. 6 is a figure showing the configuration of the switching circuit in an image forming device according to the second preferred embodiment;

FIG. 7 is a figure showing the relationship between operation of the cooling fan, temperature of the fixing roller, and temperature within the image forming device in an image forming device according to the second preferred embodiment;

FIG. 8 is a figure showing the relationship between operation of the cooling fan, temperature of the fixing roller, and temperature within the image forming device in an image forming device according to conventional art; and

FIG. 9 is a figure showing the relationship between operation of the cooling fan, temperature of the fixing roller, and temperature within the image forming device in an image forming device including a thermoelectric conversion device according to conventional art.

### DETAILED DESCRIPTION OF THE PREFERRED EMBODIMENTS

The following is a detailed explanation of the preferred embodiments of the present invention, based upon the drawings.

### First Preferred Embodiment

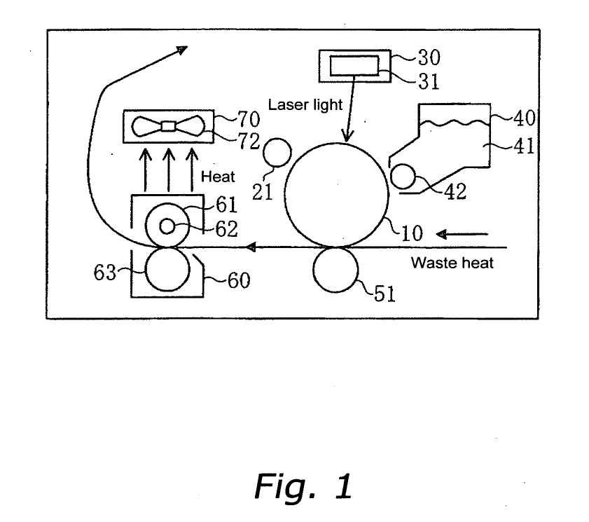

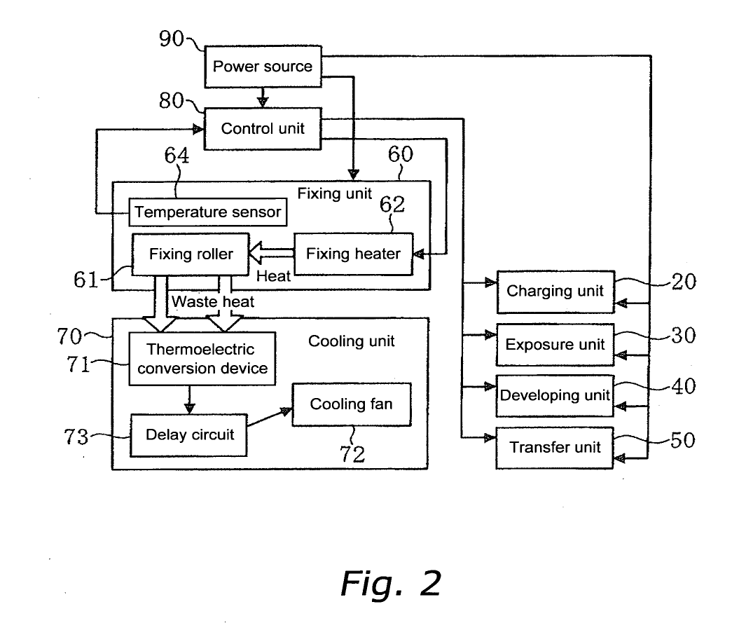

As shown in FIG. 1 and FIG. 2, the image forming device according to a first preferred embodiment includes a photosensitive drum 10; a charging unit 20 that charges the entire surface of the photosensitive drum 10; an exposure unit 30 that irradiates the surface of the photosensitive drum 10 with laser light; a developing unit 40 that develops by applying toner 41 to the surface of the photosensitive drum 10; a transfer unit 50 that transfers the toner 41 adhering to the surface of the photosensitive drum 10 to sheets; a fixing unit 60 that fixes toner 41 that has been transferred onto a sheet onto the sheet; and a cooling unit 70 that generates electricity using waste heat from the fixing unit 60 and cools the exposure unit 30 and the developing unit 40.

Also, as shown in FIG. 2, the image forming device includes a control unit 80 that controls the operation of all the devices within the image forming device, and a power supply unit 90 that supplies electrical power to the charging unit 20, the exposure unit 30, the developing unit 40, the transfer unit 50, and the fixing unit 60. The image forming device carries out a charging process, an exposure process, a developing process, a transfer process, and a fixing process in sequence.

In an image forming device with this configuration, the charging unit 20 includes a charging roller 21 as shown in FIG. 1. In the charging process the surface of the photosensitive drum 10 is charged by the charging roller 21. Also, the exposure unit 30 includes a laser scanner unit 31 as shown in FIG. 1. In the exposure process laser light is emitted from the laser scanner unit 31 to the photosensitive drum 10, forming an electrostatic latent image on the part of the surface of the photosensitive drum 10 which the laser light strikes. The optical system of the laser scanner unit 31 of the exposure unit 30 uses a resin lens (not shown in the drawings).

Also, as shown in FIG. 1, the developing unit 40 includes a developing roller 42 and also contains toner 41 within the developing unit 40. In the developing process the developing roller 42 conveys charged toner 41 and applies it to the electrostatic latent image formed on the surface of the photosensitive drum 10 to develop the image. Furthermore, the transfer unit 50 includes a transfer roller 51 as shown in FIG. 1. In the transfer process the toner 41 adhering to the surface of the photosensitive drum 10 is transferred to a sheet passing between the transfer roller 51 and the photosensitive drum 10.

Also, as shown in FIG. 1 and FIG. 2, the fixing unit 60 includes a fixing roller 61, a fixing heater 62 that heats the fixing roller 61, a pressure roller 63, and a temperature sensor 64 that measures the temperature of the fixing roller 61. The fixing heater 62 and the temperature sensor 64 are connected to the control unit 80. The temperature of the fixing roller 61 is measured by the temperature sensor 64 and the temperature information measured by the temperature sensor 64 is input to the control unit 80. Then the control unit 80 controls the temperature of the fixing heater 62 based upon this temperature information. Also, in the fixing process the fixing roller 61 is heated by the fixing heater 62, so that the toner 41 on a sheet passing between the fixing roller 61 and the pressure roller 63 is melted and fixed onto the sheet.

When the fixing unit 60 is operating in this way, although part of the heat of the heated fixing roller 61 is used as heat energy to melt the toner 41 on a sheet, most of the heat is dissipated to the surroundings from the fixing roller 61 as waste heat. When high temperature waste heat emitted from the fixing roller 61 to the surroundings is transferred outside the fixing unit 60, the temperature within the image forming device rises. This can cause hardening of the toner 41 housed within the developing unit 40, or deformation of the resin lens within the laser scanner unit 31.

To prevent this, as shown in FIG. 1, the image forming device according to this preferred embodiment includes a cooling unit 70 to prevent accumulation of heat within the image forming device and cool the exposure unit 30 and developing unit 40 by cooling the fixing unit 60. The cooling unit 70 is provided close to the fixing unit 60, as shown in FIG. 2, and includes a thermoelectric conversion device 71, a cooling fan 72, and a delay circuit 73 containing an integrating circuit. The thermoelectric conversion device 71 of the cooling unit 70 converts the waste heat of the fixing roller 61 into electrical energy, and supplies electrical power to the cooling fan 72 via the delay circuit 73.

The thermoelectric conversion device 71 can be a device using the Seebeck effect. Specifically, the thermoelectric conversion device 71 includes a high temperature electrode near the fixing roller 61, a low temperature electrode on the opposite side, and p-type semiconductor and n-type semiconductor therebetween. In this case the low temperature electrode is at the temperature of the interior of the image forming device. Also, when the fixing roller 61 is at a predetermined high temperature condition, a thermoelectromotive force is generated between the two electrodes due to the temperature difference between high temperature electrode and the low temperature electrode. The electrical power generated by thermoelectric conversion is used as the power to drive the cooling fan 72.

In this way, in the image forming device of this preferred embodiment the cooling fan 72 is driven by electrical power obtained by converting waste heat from the fixing roller 61 into electrical energy in the thermoelectric conversion device 71. On the other hand, the other components apart from the cooling fan 72 (for example, the fixing heater 62, etc.) are supplied with electrical power by the power supply unit 90. In other words, in the image forming device the power sources for the cooling fan and for components other than the cooling fan are different.

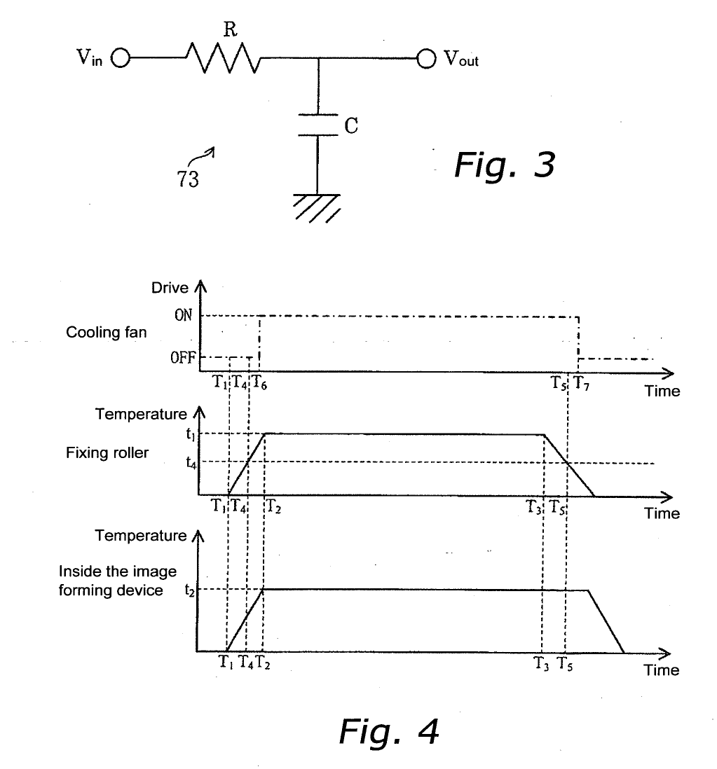

Also, in the cooling unit 70, the delay circuit 73 provided between the thermoelectric conversion device 71 and the cooling fan 72 is configured as an integrating circuit as shown in FIG. 3. That is, the integrating circuit includes an input terminal Vᵢₙ to which the output voltage from the thermoelectric conversion device 71 is input; a resistance R a first end of which is connected to the input terminal Vᵢₙ; a condenser C a first end of which is connected to a second end of the resistance R and a second end of which is grounded; and an output terminal Vₒᵤₜ connected to the node to which the resistance R and the condenser C are connected. The output voltage output from the output terminal Vₒᵤₜ is supplied to the cooling fan 72.

Then, when the voltage obtained by converting heat energy into electrical energy in the thermoelectric conversion device 71 is applied to the input terminal Vᵢₙ, the voltage required to drive the cooling fan appears on the output terminal Vₒᵤₜ, delayed only in accordance with the time constant RC.

—Operation of the Image Forming Device—

The following is an explanation of the operation of the image forming device, referring to FIGS. 2 to 4.

As shown in FIG. 2, when the power supply to the image forming device is turned ON, the power supply unit 90 supplies electrical power to the charging unit 20, the exposure unit 30, the developing unit 40, the transfer unit 50, the fixing unit 60, and the control unit 80. In addition, the charging unit 20, the exposure unit 30, the developing unit 40, the transfer unit 50, and the fixing unit 60 are controlled by the output signals from the control unit 80. Therefore, the above-mentioned charging process, exposure process, developing process, transfer process, and fixing process can each be carried out in sequence.

As shown in FIG. 4, at the time T₁ in which the power supply to the image forming device is turned ON, electrical power is supplied from the power supply unit 90 to the fixing unit 60. Then the fixing heater 62 heats the fixing roller 61, and the temperature of the fixing roller 61 gradually rises. During this time temperature information from the temperature sensor 64 is input to the control unit 80, and the temperature of the fixing heater 62 is controlled by signals output by the control unit 80. Then at the time T₄ when the temperature of the fixing roller 61 reaches t4 thermoelectromotive force is generated in the thermoelectric conversion device 71.

On the other hand, the delay circuit 73 configured as an integrating circuit as shown in FIG. 3 is provided between the thermoelectric conversion device 71 and the cooling fan 72. Therefore, although at time T₄ thermoelectromotive force is generated in the thermoelectric conversion device 71, a delay is generated by the action of the integrating circuit. At time T₆ when the voltage of the output terminal Vₒᵤₜ becomes sufficient to drive the cooling fan 72 the cooling fan 72 starts to be driven. On other words, even after a thermoelectromotive force is generated by the thermoelectric conversion device 71, the cooling fan 72 remains static for a while. The time at which the cooling fan 72 starts to be driven is delayed by (T₆-T₄) from the time at which a thermoelectromotive force is generated in the thermoelectric conversion device 71.

Also, at time T2 when the temperature of the fixing roller 61 rises to t₁, the temperature of the fixing heater 62 is controlled by signals from the control unit 80, and thereafter the temperature of the fixing roller 61 is maintained constant. Also, as the temperature of the fixing roller 61 rises, the temperature within the image forming device also rises. At the time T₂ when the fixing roller 61 reaches t₁, the temperature within the image forming device reaches t₂, and thereafter is maintained constant. In this way, the time at which the cooling fan 72 starts to be driven is delayed relative to the time at which a thermoelectromotive force is generated within the thermoelectric conversion device 71. Therefore, the rate of temperature rise of the fixing roller 61 is higher than in a conventionally configured image forming device in which electrical power is supplied to the cooling fan 72 at the same time as a thermoelectromotive force is generated in the thermoelectric conversion device 71. In other words, as shown in FIG. 4, the slope of the graph representing the change in temperature of the fixing roller 61 is steeper. The time for the temperature of the fixing roller 61 to reach t1 is shortened, and the time for the fixing roller 61 to reach the temperature necessary for fixing is also reduced.

Thereafter, as shown in FIG. 4, when the power supply to the image forming device is turned OFF at time T₃, the electrical power from the power supply unit 90 to the charging unit 20, the exposure unit 30, the developing unit 40, the transfer unit 50, the fixing unit 60, and the control unit 80 is turned off. Therefore, electricity to the fixing heater 62 is also turned off, and the temperature of the fixing roller 61 gradually falls from t₁. Then, at time T₅ when the temperature of the fixing roller 61 falls to t₄ the thermoelectromotive force in the thermoelectric conversion device becomes zero.

However, at the time T₅ when the thermoelectromotive force in the thermoelectric conversion device 71 becomes zero, electric charge is accumulated in the condenser C of the delay circuit 73 configured as an integrating circuit as shown in FIG. 3. A voltage capable of driving the cooling fan 72 is output from the output terminal Vₒᵤₜ, so electrical power continues to be supplied to the cooling fan 72 for a while after the thermoelectromotive force of the thermoelectric conversion device 71 has become zero. Then the voltage at the output terminal Vₒᵤₜ reduces due to the electrical discharge of the condenser C, and at time T₇ the output voltage from the delay circuit 73 reduces to a level at which it cannot drive the cooling fan 72, and electrical power supply to the cooling fan ceases. In other words, in the image forming device according to this preferred embodiment, the time for which the cooling fan 72 continues to be driven after the power supply to the image forming device is turned OFF is increased by (T₇-T₅) compared with a conventional image forming unit.

In this way, by providing a delay circuit 73 configured as an integrating circuit as shown in FIG. 3 between the thermoelectric conversion device 71 and the cooling fan 72, it is possible to increase the length of time that the cooling fan 72 is driven after the power supply to the image forming device is turned OFF by (T₇-T₅) compared with a conventional image forming device. Also, after turning the power supply to the image forming device OFF, it is possible to reliably prevent the temperature within the image forming device from temporarily rising higher than t₂ due to the effect of the waste heat from the fixing roller 61. Also, by delaying the time at which the cooling fan 72 starts to be driven by (T₆-T₄) after the thermoelectromotive force is generated in the thermoelectric conversion device 71 it is possible to shorten the time for the temperature of the fixing roller 61 to reach the temperature necessary for fixing. Therefore the time from turning the power supply to the image forming device ON until the fixing process can start can be shortened.

### Second Preferred Embodiment

The second preferred embodiment of the present invention is a modification of the image forming device according to the first preferred embodiment. The following is an explanation of the points in which the image forming device according to the second preferred embodiment differ from the first preferred embodiment.

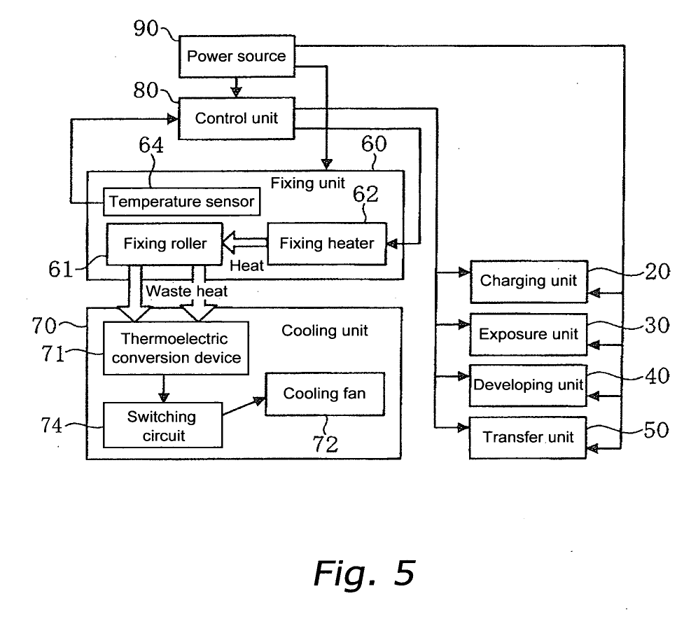

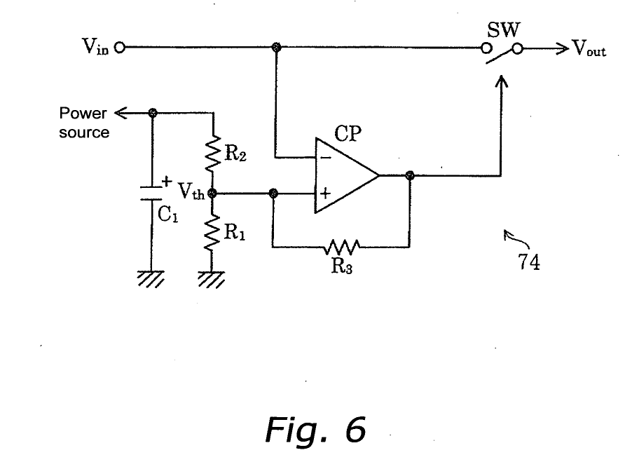

In the image forming device according to the present preferred embodiment, in the cooling unit 70 a switching circuit 74 including a comparator as shown in FIG. 6 is provided between the thermoelectric conversion device 71 and the cooling fan 72, as shown in FIG. 5.

The switching circuit 74 includes an input terminal Vᵢₙ at which the voltage output from the thermoelectric conversion device 71 is input; a resistance R₁ a first end of which is connected to ground; a resistance R₂ a first end of which is connected to a second end of the resistance R₁ and a second end of which is connected to the power supply; a condenser C₁ a first end of which is connected to ground and a second end of which is connected to a second end of the resistance R₂; a comparator CP the inverting input terminal of which is connected to the input terminal Vᵢₙ and the non-inverting input terminal of which is connected to the node to which the resistance R₁ and the resistance R₂ are connected; a switch SW a first end of which is connected to the input terminal Vᵢₙ and a second end of which is connected to an output terminal Vₒᵤₜ; and a resistance R₃ connected between the non-inverting input terminal of the comparator CP and the output terminal Vₒᵤₜ. The voltage output from the output terminal Vₒᵤₜ is supplied to the cooling fan 72.

Also, the switching circuit 74 controls turning ON and OFF the switch SW by the output of the comparator CP. Specifically, in the switching circuit 74, when the voltage applied to the input terminal Vᵢₙ, that is the voltage applied to the inverting input terminal of the comparator CP, rises to the level of the voltage applied to the non-inverting input terminal of the comparator CP, it becomes low. Therefore the voltage is output from the output terminal Vₒᵤₜ with the switch SW ON. On the other hand, when the output of the comparator is low, when the voltage applied to the input terminal Vᵢₙ, that is the voltage applied to the inverting input terminal of the comparator CP, falls to the level of the voltage applied to the non-inverting input terminal of the comparator CP, the comparator output becomes high. Therefore the voltage output from the output terminal is zero with the switch SW OFF.

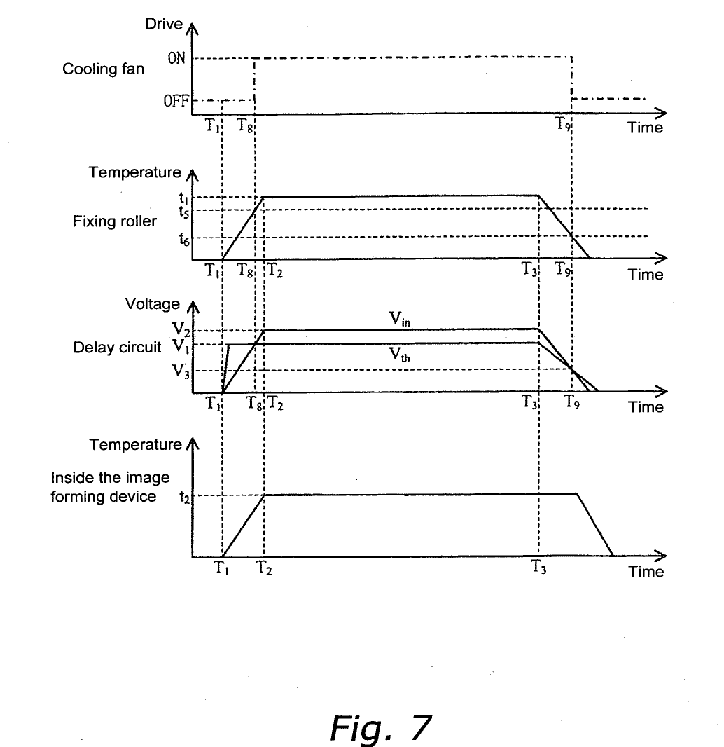

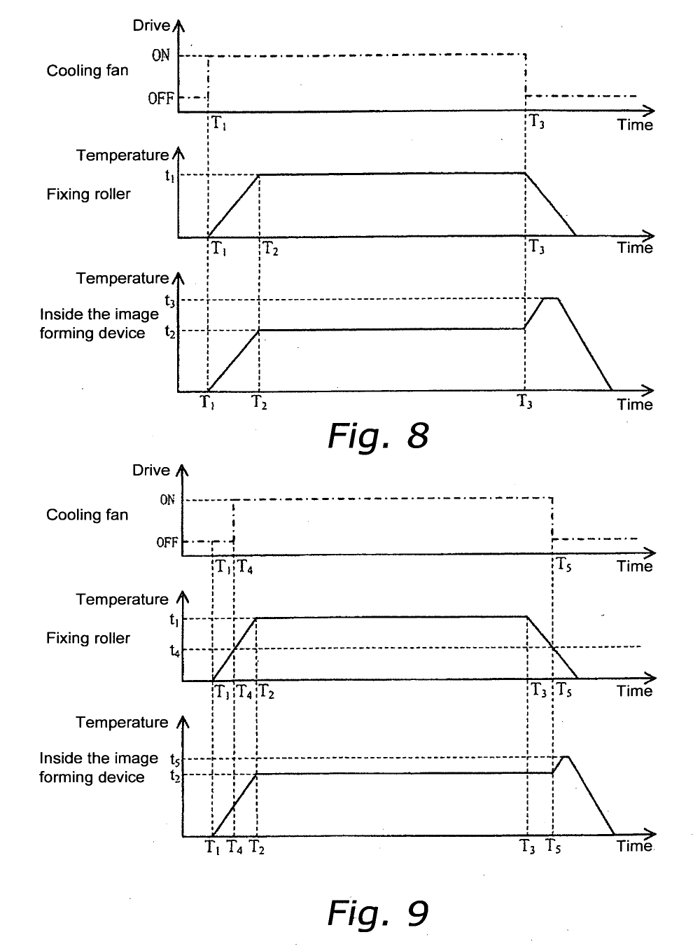

In an image forming device configured in this way, as shown in FIG. 7, when the power supply to the image forming device is turned ON at time T₁, the fixing roller 61 is heated by the fixing heater 62 and the temperature of the fixing roller 61 gradually rises. Also, in the switching circuit 74 shown in FIG. 6, the power supply voltage is applied to the node at which the resistance R₂ and the condenser C₁ are connected. The voltage applied to the non-inverting input terminal of the comparator CP Vₜₕ becomes V₁ slightly delayed from T₁ due to the influence of the condenser C₁. In addition, the voltage applied to the input terminal Vᵢₙ is proportional to the temperature difference between the high temperature electrode and low temperature electrode of the thermoelectric conversion device 71, so the voltage increases as the temperature of the fixing roller 61 rises.

Then at time T₈ when the temperature of the fixing roller 61 has risen to t₅ which is higher than t₆, the voltage applied to the input terminal Vᵢₙ becomes Vᵢₙ, equal to the voltage applied to the non-inverting input terminal of the comparator CP Vₜₕ. The switch SW of the switching circuit 74 shown in FIG. 6 is turned ON and an output voltage is output from the output terminal Vₒᵤₜ, electrical power is supplied to the cooling fan 72 and the cooling fan 72 starts to be driven.

Furthermore, at time T₂ when the temperature of the fixing roller 61 rises to t₁, the temperature of the fixing heater 62 is controlled by output signals from the control unit 80, and thereafter the temperature of the fixing roller 61 is maintained constant. Therefore the voltage applied to the input terminal Vᵢₙ becomes V₂.

On the other hand, as shown in FIG. 7, when the power supply to the image forming device is turned OFF at time T₃, electrical power to the fixing heater 62 is stopped and the temperature of the fixing roller 61 gradually reduces. Also, when the power supply to the image forming device is turned OFF electrical charge is accumulated in the condenser C₁ of the switching circuit 74 shown in FIG. 6. Therefore the voltage Vₜₕ applied to the non-inverting input terminal of the comparator CP gradually reduces with time. Then, at time T₉ when the temperature of the fixing roller 61 has dropped to t₆ which is lower than t₅, the voltage applied to the input terminal Vᵢₙ becomes equal to the voltage Vₜₕ applied to the non-inverting input terminal of the comparator CP, V₃. The switch SW on the switching circuit 74 shown in FIG. 6 is turned OFF, voltage ceases to be output from the output terminal Vₒᵤₜ, and the cooling fan 72 ceases to be driven.

In this way, by providing the switching circuit 74 between the thermoelectric conversion device 71 and the cooling fan 72, it is possible to set the thermoelectromotive force of the thermoelectric conversion device 71 when the cooling fan 72 starts to be driven higher than the thermoelectromotive force of the thermoelectric conversion device 71 when the cooling fan 72 stops being driven. In other words, it is possible to set the temperature of the fixing roller 61 when the cooling fan 72 starts to be driven higher than the temperature of the fixing roller 61 when the cooling fan 72 stops being driven.

Therefore, according to the preferred embodiment, it is possible to delay the time at which the cooling fan 72 starts to be driven after the power supply is turned ON compared with an image forming device configured according to conventional art. Therefore it is possible to shorten the time for the temperature of the fixing roller 61 to reach the temperature required for fixing. Also, it is possible to lengthen the time that the cooling fan 72 is driven after the power supply is turned OFF compared with an image forming device configured according to conventional art. Therefore it is possible to reliably prevent the temporary rise in temperature within the image forming device due to the influence of waste heat from the fixing unit 60 after the power supply to the image forming device is turned OFF.

### Other Embodiments

The following modifications may be made to the configuration of the image forming devices according to the first preferred embodiment and the second preferred embodiment. In the following examples of variations to the image forming devices, the voltage at which the cooling fan 72 can start to be driven is provided so that it is between the voltage that can drive the cooling fan 72 and the rated voltage of the cooling fan 72. Therefore the delay circuit 73 configured as an integrating circuit as shown in FIG. 3 and the switching circuit 74 as shown in FIG. 6 can be omitted.

In an image forming device configured in this way, after the power supply to the image forming device is turned ON, as the temperature of the fixing roller 61 rises the thermoelectromotive force of the thermoelectric conversion device 71 also increases. Then, even when the thermoelectromotive force of the thermoelectric conversion device 71 reaches the voltage that can drive the cooling fan 72, the cooling fan 72 is prevented from being driven until the voltage reaches that at which the cooling fan 72 can start to be driven. Therefore, the cooling fan 72 remains static. Thereafter, when the thermoelectromotive force of the thermoelectric conversion device 71 further increases to the voltage at which the cooling fan 72 can start to be driven, the cooling fan 72 starts to be driven.

Also, after the power supply to the image forming device has been turned OFF, the thermoelectromotive force of the thermoelectric conversion device 71 reduces as the temperature of the fixing roller 61 reduces. Then the thermoelectromotive force of the thermoelectric conversion device 71 drops to the voltage at which the cooling fan 72 can be driven, which is lower than the voltage at which the cooling fan 71 can start to be driven, and subsequently as the thermoelectromotive force of the thermoelectric conversion device 71 reduces the rate of revolution of the cooling fan 72 gradually decreases, and the cooling fan 72 stops being driven.

In this way, in the image forming device of this embodiment by setting in advance the voltage at which the cooling fan 72 can start to be driven, it is possible to delay the time at which the cooling fan 72 starts to be driven after the power supply is turned ON compared with an image forming device configured according to conventional art. Therefore it is possible to shorten the time for the temperature of the fixing roller 61 to reach the temperature required for fixing.

As explained above, the present invention is useful for image forming devices, in particular image forming devices that use the waste heat of the fixing unit to cool the developing system or the optical system.

What is claimed is:

1. An image forming device, comprising:
an exposure unit in which laser light irradiates a photosensitive body to form an electrostatic latent image on the surface of the photosensitive body;
a developing unit that develops by applying toner to the electrostatic latent image formed on the surface of the photosensitive body;
a fixing unit that includes a fixing roller and a heater that heats the fixing roller, and that fixes toner onto a sheet that passes the fixing roller heated by the heater;
a thermoelectric conversion device that carries out thermoelectric conversion using waste heat of the fixing unit; and
a cooling fan that cools the fixing device,
wherein the exposure unit, the developing unit, and the fixing unit are supplied with electrical power by a power source, and the cooling fan is driven by electrical power generated by thermoelectric conversion by the thermoelectric conversion device, and the voltage directly output from the thermoelectric conversion device is higher when starting to drive the static cooling fan than when ceasing to drive the operating cooling fan.

2. The image forming device according to claim 1, further comprising a delay circuit between the thermoelectric conversion device and the cooling fan that delays the voltage output from the thermoelectric conversion device to the cooling fan and outputs the voltage to the cooling fan.

3. The image forming device according to claim 2, wherein the delay circuit comprises:
an input terminal at which the output voltage from the thermoelectric conversion device is input;
a resistance having a first end connected to the input terminal;
a condenser having a first end is connected to a second end of the resistance and a second end connected to ground; and
an output terminal connected to the connection node to which the resistance and the condenser are connected and which outputs the output voltage to the cooling fan.

4. The image forming device according to claim 1, further comprising a switching circuit so that when the cooling fan is static and when the voltage output from the thermoelectric conversion device reaches a first predetermined voltage electrical power is supplied from the thermoelectric conversion device to start to drive the cooling fan, and when the cooling fan is operating and when the voltage output from the thermoelectric conversion device reaches a second predetermined voltage the supply of electrical power from the thermoelectric conversion device to the cooling fan stops, wherein the first predetermined voltage is higher than the second predetermined voltage.

5. The image forming device according to claim 4, wherein the switching circuit comprises:
an input terminal at which the output voltage from the thermoelectric conversion device is input;
a first resistance having a first end connected to ground;
a second resistance having a first end connected to a second end of the first resistance and a second end connected to the power source;
a condenser having a first end connected to ground and a second end connected to a second end of the second resistance;
a comparator having an inverting input terminal connected to the input terminal and a non-inverting input terminal connected to the connection node connecting the first resistance and the second resistance;
a switch having a first end connected to the input terminal;
an output terminal connected to a second end of the switch and that outputs the output voltage to the cooling fan; and
a third resistance having a first end connected to the non-inverting input terminal of the comparator and a second end connected to the output terminal.
